(19) United States
(12) Patent Application Publication
(10) Pub. No.: US 2019/0345913 A1
(43) Pub. Date: Nov. 14, 2019

(54) WIND TURBINE OR WATER TURBINE WITH VORTEX EFFECT AND SEQUENCE FOR OUTER LATERAL COMPRESSION-TILTING-EJECTION OF AN INCIDENT FLUID, FACING THE IMPELLER

(71) Applicants: Alain SALOU, Colombes (FR); Alexandre SALOU, Colombes (FR)

(72) Inventors: Alain SALOU, Colombes (FR); Alexandre SALOU, Colombes (FR)

(21) Appl. No.: 16/476,082

(22) PCT Filed: Nov. 7, 2017
(86) PCT No.: PCT/FR2017/000208

§ 371 Date: Jul. 4, 2019

(30) Foreign Application Priority Data
Jan. 5, 2017 (FI) 1700012

(51) Int. Cl. F03D 3/06; F03B 3/12

(52) U.S. Cl. CPC F03D 3/061; F03B 3/121

(57) ABSTRACT

The invention relates to a high-performance device, which allows energy to be collected from a moving fluid by an impeller, wind turbine or water turbine. The device opposes the stream of the incident fluid by blades having concave surfaces, in winch the perpendicular (or the orthogonal), erected on the surface of the blade, is substantially secant with the axis of rotation of the impeller, in order to discharge the fluid after compression, simultaneously: vertically, with vortex effect, and then laterally after tilting by tangential election of the fluid to the outside of the impeller. This is different from known wind turbines, which allow the incident fluid to transit by die centre of rotation thereof to engage with the convex portion of the blades from tile inside towards the outside or with the drag coefficient of the profile (referred to as ex) of the blades of the impeller. The device according to the invention is particularly interesting the field of renewable energy in urban or mountainous environments, where the flows are turbulent.

The present invention relates to a new concept of vertical axis impeller which instead of allowing the flow to pass conventionally and predominantly between the blades, passing through its centre of rotation to reach convex active surfaces, it repels the flow by CONCAVE external active surfaces or limited in concavity, thus opposing the passage of the flow through the centre of rotation.

In this new concept, in order to ensure optimum efficiency, the perpendicular erected on the surface of the concavity of the blades will interfere, will be secant, with the axis of rotation of the device. This design with a vertical shaft according to a new principle, which is the subject matter of the invention, will generate a strong starting torque, simultaneously involving two force vectors in two orthogonal directions, one tangential, conventional, about the axis of rotation, the other vertical of autorotation resulting from a vortex effect.

The use of this new impeller in the wind power application, being aesthetic and quiet, will therefore be able to be used favourably in the urban environment where the air flows are turbulent due to the buildings, or in mountains, in zones with specific swirling winds.

In contrast to the conventional Darrieus or Savonius wind turbines, which have their initial force vector collinear with the wind direction for the first principle called impulse mode (ex) with direction approximately perpendicular to the convexity of the active blade, the second in suction mode called fineness under the wind, with a force vector acting from the interior to the exterior of the impeller, which does not allow optimization of a vortex effect, the fluid being expanded in lateral orientation on leaving the blades, even sometimes joined together at their end, thus interfering with vertical ejection, as in the new operating principle of the present invention. The object of the present invention, with angles of attack and blade shapes reversed, relative to the incidence of the wind, which gives it a strong starting torque found in experiments, compared with the existing systems, that it is sometimes necessary to spin at the start of their rotations, a wind turbine on the Savonius principle obtains its maximum power when its rotation stabilizes in so-called fineness mode near 32 degrees of angle relative to the wind, apparent mainly at high rotary speed, the action of the wind then being exerted on passing through the wind turbine and on acting on the convex part of the blades as a sail of a sailing boat from the interior to the exterior. In the Darrieus system which starts easily, there is little or no vortex effect, the blades are far apart and the rotation of the wind turbine is generated by the differential of coefficient of drag (CD) facing the wind, between the opposite blades relative to the axis of rotation, this principle only attains low rotary speeds, owing to the turbulence that develops on the rear face (the extrados) of the blades, this parasitic turbulence opposes rotation, which is why it is usual to combine a wind turbine of each aforementioned principle on one and the same shaft, one for starting, the other for power at high rotary speed, in fineness mode. The principle of this new design of vertical axis wind turbine with concave blades facing the wind, and force vectors oriented outwards provides the advantages of the two conventional principles without the drawbacks, with this new concept the following steps occur in succession on the face FC1 (FIG. 7) pressure of the air flow on the concave blade in the form of a gutter that channels the flow, forces the air along the vertical then simultaneously sliding of the air FIG. 1, tangentially according to the arrow (Z) from the surface SEF1, causing the face FC1 to pass, from the blade (G) initially against the wind, to a position under the wind. The blade (G) will then be replaced by the blade (E) at the start under the wind and masked by (G), the blade (E) will then be in a position facing the concavity, FC2 facing the wind. According to one variant the blades of the wind turbine may be made off-centre to improve their efficiency, by a value (X1) see (FIG. 1) and (FIG. 2) that will be optimized in tests as a function of the characteristics of the windswept zones. In this new concept the active forms will always be concave, exposed facing the wind, at each half-turn one blade will mask another (G) masks (E), (E) masks (G) and so on, in contrast to the two conventional principles, whether either the blade activated by the air flow is convex (Savonius), or a blade never masks another (Darrieus). In this novel invention the succession of steps of compression-expulsion-tilting-ejection-expansion, simultaneously vertically and laterally will be in sequence along two axes, one vertical with formation of an expansion vortex by compression (FIG. 10), ejection (FIG. 11), expansion-discharge (FIG. 12), with inverted cone (FIG. 7), with tip at the centre of the wind turbine broadening under the effect of the rotation (mini-tornado effect), the other collinear with the vector rotation following compression of the air flow and tilting of (G) according to (FIG. 1) the direction (Z) towards the second blade masked under the wind (E) which will then pass to the wind, the rear end of (G) then entering a depression zone (H) of suction thus cancelling the effect of the impulse zone (A) (FIG. 2), not forgetting the front end of the blade (G) now under the wind which will promote rotation, being in a masked aspiration zone (B) with such kinematics an effect of depression-suction will also appear behind the concave part (FIG. 2) of the leading edge of the blade (E) now against the wind promoting the efficiency, compared to the other existing systems, this new principle will act by simultaneous action of two force vectors, one due to a vortex effect in expansion by vertical discharge of the air flow after compression-expansion (FIG. 10), the other with lateral peripheral orientation, it too by compression of the gas (FIG. 10) and discharge-ejection (FIG. 11). In contrast to the operation of the other vertical wind turbines it was found that this new wind turbine benefited from positive accelerations between the compression phase and the discharge phase, with a slight, barely audible cavitation noise with the rotation, and that the vortex effect was amplified, with the rotary speed, thus regulating the discharge of the gas from its transition to compression in the discharge-expansion phase.

According to one version, the wind turbine would have linear concave faces, according to another version these concave faces relative to the incident wind would be circular, parabolic. Such a design gives efficiency more than twice as high as the efficiency of conventional wind turbines, owing to a swept area of air in action far greater than that of a conventional wind turbine for an identical overall diameter of impeller, with the aforementioned advantage of autoregulation in rotary speed by the vortex effect, which will continue for some seconds transiently after the decrease in the intensity of a gust. FIG. 1 shows, in zone (SEF1), the concave surface (FC1), in the form of a gutter, which firstly opposes the passage of the filaments of air laterally, expelling the air vertically and parallel to the axis of rotation, generating a large movement of spin, “vortex type” of radius (RCV1) of centre (CV1) then tilts causing rotation of the wind turbine, the blade under the wind up to then masked zone (ZM) becomes active. In this new concept of wind turbine the blades (E) and (G) FIGS. (1) and (7) are symmetrically opposite, and at each half-turn of the impeller, are alternately either in a position masked under the wind or in an active position with the concave outer face facing the wind, it should be noted (FIG. 1) that the projection of the concave active surface of the blade (G) on the axis of rotation of the wind turbine will vary as a function of its position, relative to the incident wind, at an angle alpha (FIG. 1 then FIG. 2) in its rotation, minimum at the start, maximum before tilting, with in consequence a variable force as a function of the wind. (The angle alpha being the angle between the perpendicular from the plane of the blade (G) passing through the axis of rotation, and the axis of the wind).

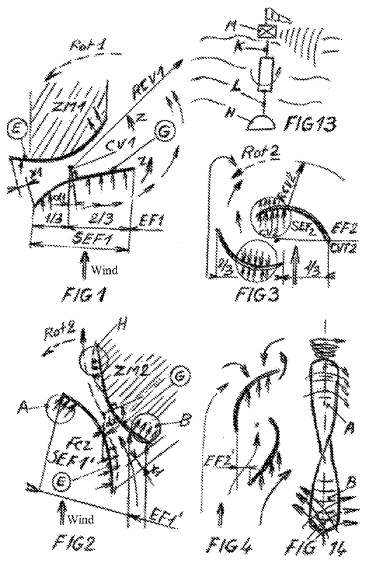

FIG. 3 shows the classical circuit of the filaments of air which, in contrast to the effects in FIG. 1, impact firstly on the convex face of the blade against the wind, secondly activate the surface SEF2 of the blade under the wind, the filaments passing in this case through the centre of the wind turbine, the vertical discharge of the filaments of air is slight owing to the joining of the blades at the ends with in consequence a small vortex effect of radius RCV2.

For an identical wind turbine diameter, according to this new design (FIG. 1), the active surface FC1 facing the wind is of large area and “CONCAVE” before it tilts, in the conventional design (FIG. 3) the surface facing the wind is “CONVEX”, its smaller active surface is placed under the wind.

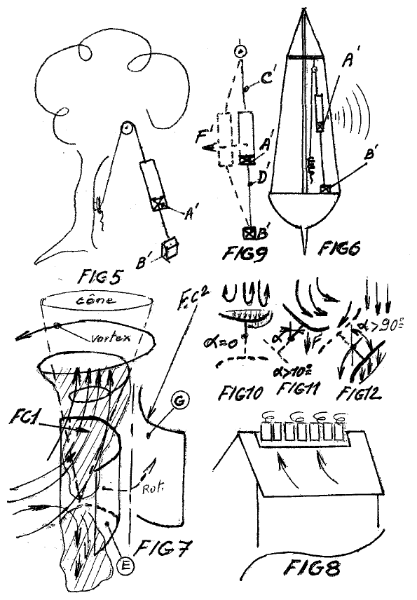

FIG. 2 shows the position of the blades of the new concept after a quarter-turn of rotation and tilting from FC1 to FC2, the rotation will then accelerate with additional action of the wind on the front end (B) of the blade under the wind, and of its masked rear part (ZM), in a conventional design, (FIG. 3) after the same quarter-turn of the conventional wind turbine will have the position in (FIG. 4), the action of the wind on the wind turbine will in this case be approximately zero. The new design of wind turbine is therefore active whatever the direction of the wind or its incidence on the blades, in a classical design this is not the case, in fact in the particular case of the position of the blades in FIG. 3 relative to the wind the wind turbine does not generate any motive torque. FIG. 7 is a reminder of the two simultaneous effects of the wind on the concave blade (FC1) facing the wind. An action of vertical expulsion of the air flows compressed by a gutter effect (channeling of the air) with vertical discharge, at the top or the bottom before its sudden expansion causing a large swirling effect owing to the simultaneous rotation of the impeller, a vortex of air will be the result, a “spin” movement then “vortex” effect accelerating the rotation of the wind turbine with in consequence a rotating driving action as described in the aforementioned FIGS. 1 and 2. According to one use (FIG. 5), this wind turbine equipped with a small generator could be coupled to a shaft to provide replacement electricity production in the country or the mountains. According to another use (FIG. 6), this wind turbine with concave face against the wind may be hoisted to the top of the mast of a boat, sailing boat, or other, to serve as active radar echo for anti-collision against an oil tanker for example, by accelerating and returning by the Doppler effect the waves received to the radar screen of the pulse emitter, of another boat or of an aeroplane undertaking an area search thus facilitating pinpointing. Equipped with a generator (A′) or (B′), this same small wind turbine can light up the bridge of a boat at sea or at anchor in a cove at night in the case of electrical failure on board in this application the cable connecting the bridge of the boat to the generator will serve in this case as a torsion spring to amplify by accumulating and restoring alternately the torsional energy that will trigger the starting torque of the generator, the cable being fixed on the bridge of the sailing boat or other in its bottom part and connected to the generator in its top part. According to another option, the two blades would no longer be face to face but aligned (FIG. 14) with the predominantly active part (A) opposite the wind with concave type of profile, or with pseudo-concavity up to the limit of flatness, part (B) becoming active after a half-turn when it will expose in its turn its concavity facing the wind. According to another version the cable (C′) would be free to rotate relative to the wind turbine, and the generator (A′) connected rotationally with the wind turbine immobilized by the cable (D′) in its bottom part, or the generator (B′) will be immobilized by the cable (D′) in its bottom part and rotated by the cable (D′). At low wind the wind turbine will be able to turn freely without resistive torque, once the wind picks up, the wind turbine will be displaced laterally, see (FIG. 9) this lateral displacement will lead to tension on the cable, this progressive tension as a function of the intensity of the air flow will be used for engaging rotational drive or modulating the excitation of the generator either at (A′) or at (13′), and thus autoregulate, the load, the output power, in harmony with the intensity of the wind. FIG. 8 shows a possible installation of the wind turbine of this new, very aesthetic concept on the roof of a dwelling, with orientation of the air flow to the concave active blades of the system, in the urban environment with turbulent winds this impeller (wind turbine) could have a number of blades greater than two which will eject the wind upwards thus accentuating the aforementioned vortex effect. Of course, the principle that is the subject matter of the present invention is not limited to the schemes in the present document, but may be applied to any impeller, or water turbine (FIG. 13) connected by a cable (K) to a generator (M) at the surface, using the principle of concave blades facing a flow incident on the entire active surface, which would escape by a gutter effect channeled parallel to the axis of rotation, and would always eject the fluid laterally to the exterior, relative to the axis of rotation, thus ensuring an auto-cleaning against possible algae, molluscs and parasitic shellfish, a cable (L) connecting the impeller to an anchorage block (N), which may thus supply a beacon at sea in overcast conditions.

1-10. (canceled)

11. Device according to FIG. 7, with a vertical-axis impeller, characterized in that it comprises two blades, in that these two blades are positioned facing one another symmetrically opposite by their convex faces, and in that at each half-turn of the impeller, one after another, each blade is either in a masked position, or in an active position, with the concave surface facing the incident fluid.

12. Device according to claim 11, characterized in that the connection is fixed, rigid, in that each blade presents its concave profile (or pseudo-concave, up to the limit of flatness) alternately at each turn of the impeller, the impeller being held either by a cable or cables, or by a conventional axis of rotation in a zone with consistent turbulence and flow.

13. Device according to claim 11, characterized in that at each turn of the impeller, the active blade, facing the incident fluid, owing to its gutter-shaped concave profile, blocks compresses-ejects outwards, simultaneously vertically forming a vortex “an expansive autoregulation vortex”, “with spin effect”, and tangentially by a tilt-expel-lateral ejection, after compression of the fluid on the blade, said fluid thus moving away from the impeller, without ever passing through its axis of rotation, in contrast to the known conventional principles “which oblige without exception” the flow to transit via the axis of rotation of the impeller.

14. Device according to claim 11, characterized in that, as the device is held by a cable or cables, its lateral displacement due to the transverse force of the fluid on the impeller causes rotation of a generator or triggers its excitation. This device in a version as an emergency wind turbine, easily transportable, can be attached to a tree in the case of mains failure, then produces replacement electrical energy in the country or in the mountains as well as hoisted to a boat mast in case of failure of the on-board electricity supply system.

15. Device according to claim 11, characterized in that the concave profile of the blade serves as active echo-radar, returning by the Doppler effect the waves received to the screen of the radar emitting pulses, as well as a generator, whether or not integrated in the impeller to facilitate pinpointing by lighting up an area.

16. Device according to claim 11, characterized in that it has more than two blades with an axis of rotation replacing the cables, while observing the principle of compression with lateral ejection without passing along the axis of rotation in the case when several wind turbines are mounted in series on a roof in order to avoid interference between the different lateral ejections of fluids, or in an irregular wooded area with strong turbulence opposing good rotation of the impeller.

17. Device according to claim 13, characterized in that, in water turbine mode, the impeller is coupled by its bottom part to a cable, the other end of which rests on the bottom of the water and with its upper part attached to an another cable or cables transmitting a rotary motion to a generator itself fixed to a buoy pulling the impeller towards the surface. According to one variant, the upper part of the impeller would be coupled to a cable itself pulled by a buoy towards the surface, and with its lower part coupled to a cable or cables transmitting a rotary motion to a generator placed on the bottom of the water. According to another option the water turbine will be free in its bottom part, without connection, and coupled to a cable that will transmit the torque to a generator located out of the water.

18. Device according to claim 14, characterized in that the cable or cables provide, by their rotary motion, a function of torsion spring, amplifying, accumulating and restoring alternately a torsion energy that will trigger the starting torque of the generator.

19. Device according to claim 11, characterized in that the two blades are no longer facing one another, but aligned, presenting a concave active face (or with pseudo-concavity) successively to the fluid at each half-turn of the impeller, generating a lateral expulsion of the fluid, then an inactive convex face, with vertical ejection of the fluid, generating a vortex, an expansive spin.

20. Device according to claim 11, characterized in that the faces of the impeller are no longer linear concave, circular concave, or concave parabolic facing the incident flow, in that in water turbine mode, the trailing edge of the blades is offset by a value (X1) in order to generate a cavitation effect in the water by the two force vectors, in principle, in claim (1) one longitudinal and the other lateral which will act together on the impeller during rotation thereof to remove and limit the possible establishment of algae, shellfish or molluscs on the active parts of the blades.
